(19) United States
(12) Patent Application Publication
(10) Pub. No.: US 2001/0014896 A1
(43) Pub. Date: Aug. 16, 2001

(54) SYSTEM FOR AUTOMATICALLY PRINTING THE SAME TITLES WITH ACCURATE MARGINS ON BOTH HALVES OF TAB INSERTS AND THE LIKE

(76) Inventors: DIEDERICH GROBE-WILDE, BOTTROP (DE); CHRISTOPHER RICHARD WOOD, PASADENA, CA (US); GHANSHYAM H. POPAT, ALTA LOMA, CA (US); GUSTAV ALLEN RAY, HUNTINGTON BEACH, CA (US)

Correspondence Address: OPPENHEIMER POMS SMITH, 2029 CENTURY PARK EAST, SUITE 3800, LOS ANGELES, CA, 90067

(21) Appl. No.: 08/791,888

(22) Filed: Jan. 31, 1997

(51) Int. Cl. G06F 15/00

(52) U.S. Cl. 707/503; 707/500

(57) ABSTRACT

The software of the present invention allows for easy and accurate printing of the same title or other indicia on both halves of a tab insert on a (perforated) sheet which is passed through a (laser) printer. The user enters the title once (into the computer) and the program automatically copies it. The entered and copied titles are added into a special table of the formatted document. Alternating rows and columns in the table are kept free of the indicia and the copied indicia and thereby define built-in margins allowing for the accurate printing placement of the indicia on the inserts. That is, the empty cells on the table enforce the margins and ensure that the printing stays on the tabs.

### BACKGROUND OF THE INVENTION

Divider pages with paper tab inserts have been commercially available from many manufacturers for many years. These products included a strip of paper with perforations and score lines on which indexing information could be printed by hand or typed in a typewriter. These strips were typically equal in width or slightly narrower than the tab into which they would be inserted. The user would carefully align the strip in the typewriter and type in the indicia in the fields defined by perforations and score lines. The strip would then be removed and the individual inserts separated from the rest of the sheet, folded over and inserted into the tab. For tabs with indicia on both sides, it was necessary to replace the insert strip in the typewriter in an inverted orientation and type in the indicia for the opposite face of the tab.

An example of such a prior product which was introduced by Dennison in 1984 is Avery Dennison's improved typewriter strip —the Quicki®—Type Insert strip. For this product the front and back-face fields of each insert are disposed in a side-by-side position rather than an over-under arrangement to eliminate the need for reversing the strip in the typewriter.

Beginning in the early mid-1980's, typewriters started being replaced in offices by personal computers with word processing software and printers as the preferred means for creating documents. The personal computer and printer provided users with a way to make their printed images easier and more attractive.

The insert strips for index dividers, however, are not configured to run successfully in desktop printing devices, since their dimensions are too small for infeed, transport and delivery systems in printers to engage. Also, their pattern of perforations, extending up to the edge of the sheet, increased the risk of tearing as the strip is transported through the printer. Thus, the consumer was faced for many years with the problem that computer printers could not accommodate existing insert strips and typewriters were disappearing from the office.

The solution was the WorkSaver® Tab Insert product (e.g., Avery® Stock No. WI-213-8, WorkSaver® Dividers with Inserts for Typewriters, Ink Jet and Laser Printers) introduced by Avery Dennison in 1993. By providing inserts laid out on a sheet having dimensions suitable for desktop printers, a software template which aided the consumer to accurately and conveniently place indicia in the correct locations and a perforation design with substantially continuous perimeter strips to reduce the risk of edge tearing during transport through the printer, the WorkSaver® products enabled consumers to prepare aesthetically-pleasing tab inserts conveniently and using available printing equipment.

Software for printing labels has been commercially available for a number of years. One example is the LabelPro® program which has been available from Avery Dennison with several different versions since 1988. A flow chart showing the steps of that program is illustrated by reference numeral 80 in FIG. 1. And a prior art label formatting table is shown at 90 in FIG. 2. However, that stand-alone program was difficult and time consuming to use, especially for inexperienced computer users. A blank label was illustrated on the computer screen pursuant to the program. The user must then figure out that he wants to put some text on it. He must drag some text object down. He creates a text object and types on it. If he wants to merge a file, he must pick a file and a merge field and put it on it. Inconveniently, he prints directly from that program and not from a word processing program.

Since desktop laser printers use unsophisticated paper feeding and paper positioning mechanisms, there is a variation in the image position on the page from one type, thickness or weight of paper to another type, thickness, or weight of paper with the same printer. Thus, attempting to print too close to the edge of the label in the past sometimes resulted in the printing running off the side of labels on some types of paper or with some printers.

### SUMMARY OF THE INVENTION

Directed to remedying the problems in the prior art, disclosed herein is an improved (computerized) system for printing titles or other indicia on both halves of index divider inserts on a carrier sheet of same. A table is set-up in the formatted document having rows and columns. No indicia is inserted by the computer program into the cells of alternating rows and columns in the table; rather, the empty alternating rows and columns define printing margins to accurately position the indicia on the insert halves as it is printed on them.

The user enters (either new or from an existing data file) the indicia to be printed on one half of the insert. The indicia is automatically copied within the software for subsequent printing on the other half. The indicia and copied indicia are entered in the appropriate cells (left and right cells in the same row in the table with a blank cell in between). The indicia and copied indicia for the next index divider tab insert are entered in respective cells beneath the first ones in another row with a blank row therebetween. Various orderings of when the table is formatted, indicia is added to the table, the indicia is copied, and the copied indicia is added are disclosed herein. When all of the indicia have been entered and upon a user prompt, the indicia are accurately centered and printed by a (laser) printer on both halves of the insert of the carrier sheet. The user separates the printed inserts from the sheet and installs them in the tabs of hanging files or index divider sheets. The carrier sheet, which is uniquely designed for the present software, has only a single centered column of microperforated inserts with wide margins of paper on both sides thereof.

That is, the indicia, title or information is automatically copied in the software from the left to the right half of the insert. More specifically, a copy, internal to the software, of the text that is on the left side of the first insert is made. The copied text is placed on the right side of the first insert. A copy internal to the software is made of the text on the left side of the second insert. And the copied text is placed on the right side of the second insert. The process is repeated for all of the remaining inserts. When this product is selected by the user, a special code in the software file says that indicia in the left column needs to be copied into the right column. Also, skipping columns and rows in the table enforces the margins and ensures that the entire text is printed on the tabs. Thus, even though the printer alignment may be off, the words will be printed on the tab and not run off of the edges thereof.

The system can utilize a personal computer, a “thin client” computer or a Web television. Also, the software can be installed via computer disk, over the Internet, as an applett or ActiveX. That is, instead of providing the subject program or software to the user on a computer disk, it can be provided using an applett or activex, independent of the computer's operating system and distributed over the internet. Other application (distribution) systems as would be apparent to those skilled in the art are also within the scope of this invention.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a flow chart of a prior art label printing process;

FIG. 2 is a view of a label printing format of the prior art;

FIG. 3 is a perspective view of a system of the present invention;

FIG. 4 is a top plan view of the tab insert carrier sheet of the system of FIG. 3 shown enlarged and in isolation;

FIG. 5 is a side edge view of the sheet of FIG. 4;

FIG. 6 is a bottom view thereof;

FIG. 7 is an end edge view thereof;

FIG. 8 is an enlarged cross-sectional view taken on line 8-8 of FIG. 4;

FIG. 9 is an enlarged cross-sectional view taken on line 9-9 of FIG. 4;

FIG. 10 is an enlarged view taken on circle 10 of FIG. 4;

FIG. 11 is a perspective view of the sheet of FIG. 4 after a printing operation thereon and showing the procedure of removing the divider inserts and inserting them into an index tab divider;

FIG. 12 is a flow chart showing the computerized process of the present invention, which is implemented with the system of FIG. 3;

FIGS. 13, 14, 15, 16, 17, and 18 are, respectively, first, second, third, fourth, fifth and sixth screen shots pursuant to the process of FIG. 12 and as viewed on the computer monitor of the system of FIG. 3; and

FIG. 19 is a view showing a formatted table of the present invention.

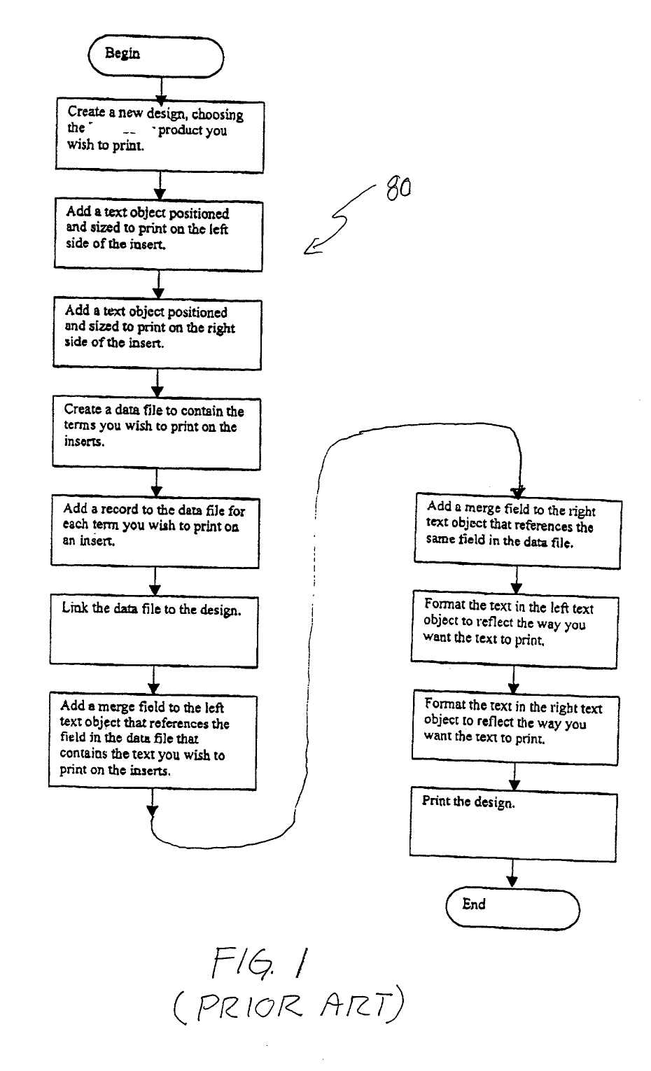

### DETAILED DESCRIPTION OF PREFERRED EMBODIMENTS OF THE INVENTION

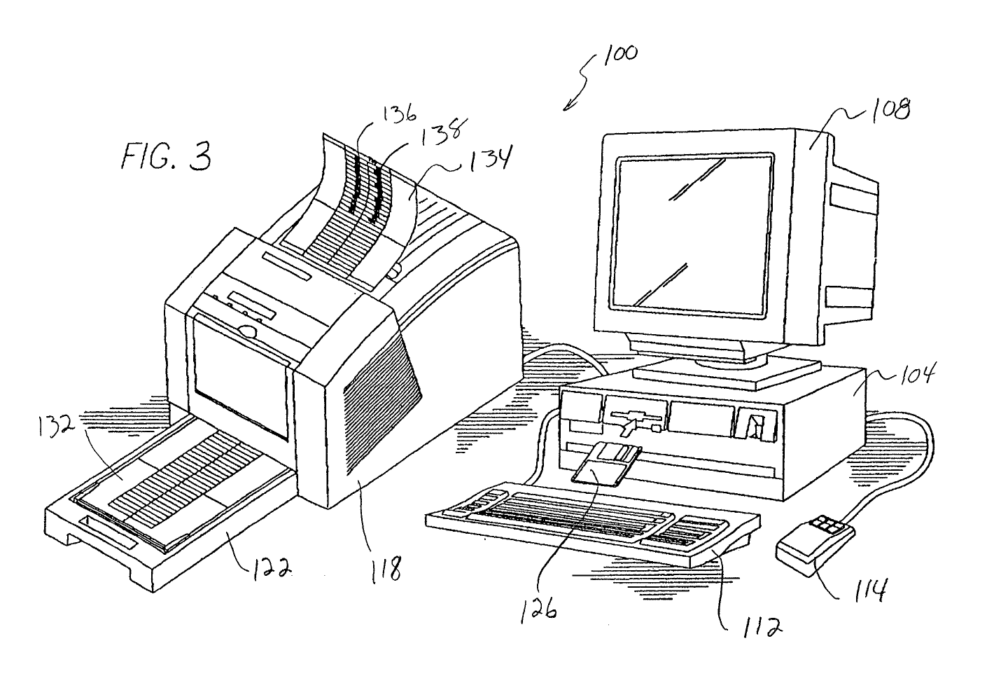

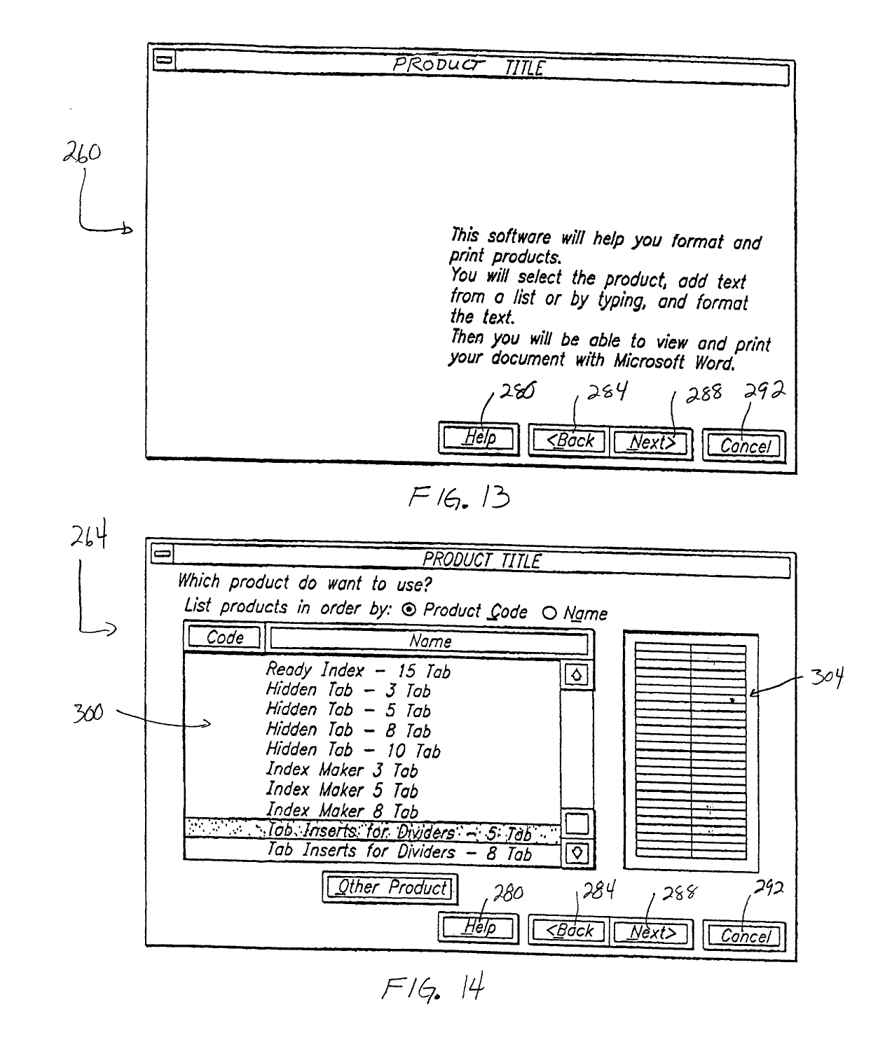

Referring to FIG. 3, a computer printing system of the present invention is illustrated generally at 100. System 100 includes a computer 104, a computer monitor 108, a keyboard 112, a mouse 114 and a printer 118 having a feed tray 122. The computer 104 is preferably a personal computer available from many retail outlets and having the following specifications: Intel Pentium processor, 16 MB of memory, 1 GB hard drive, keyboard, mouse, connection to a printer, a Windows operating system, and a version of the Microsoft Word® word processing program. Likewise, the printer 118 is preferably a desktop laser or ink jet printer available from many retail outlets and having the following specifications: 8.5 inch×eleven inch and/or A4 paper size and two to twelve page per minute printing speed. A computer program (see FIG. 12) of this invention is shown in FIG. 3 being inserted via a computer disk 126 into the computer 104 for installation of the program.

Also, illustrated in FIG. 3 is a microperforated index tab divider sheet 132 of the present invention shown in the printer feed tray 122; a similar sheet 134, but with the columns of indicia 136 and 138 printed thereon by the printer 118, is shown leaving the printer.

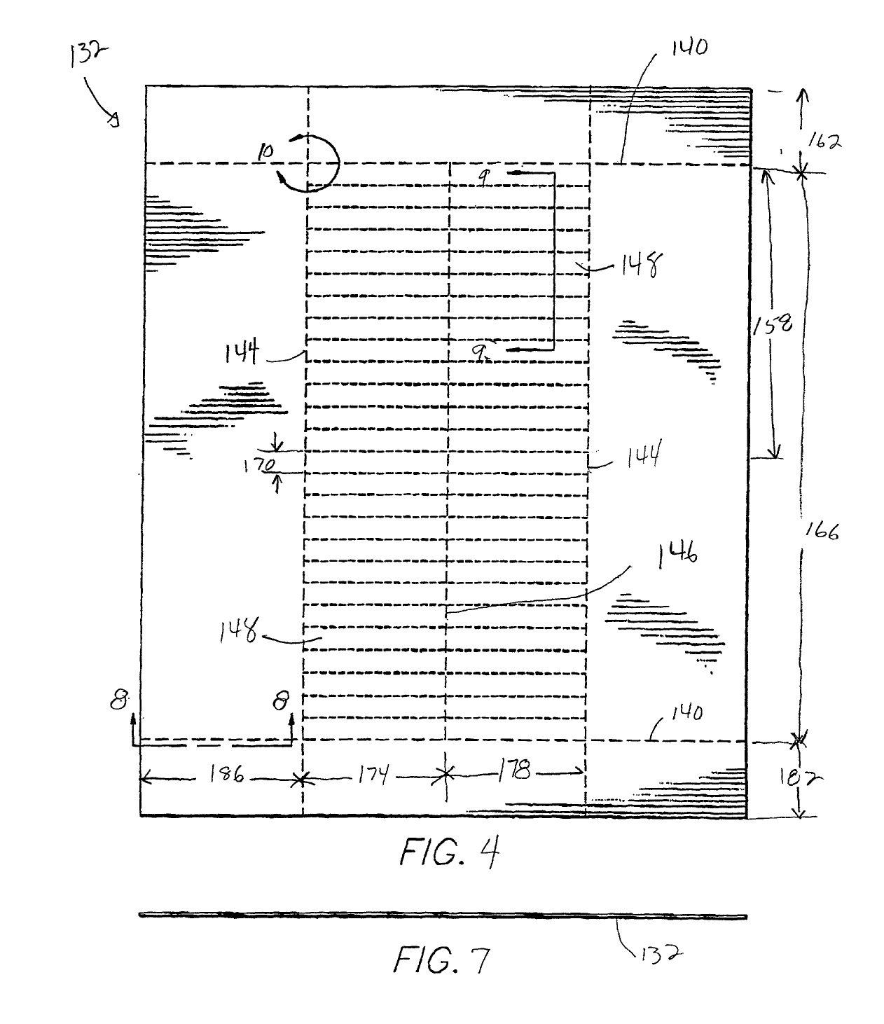

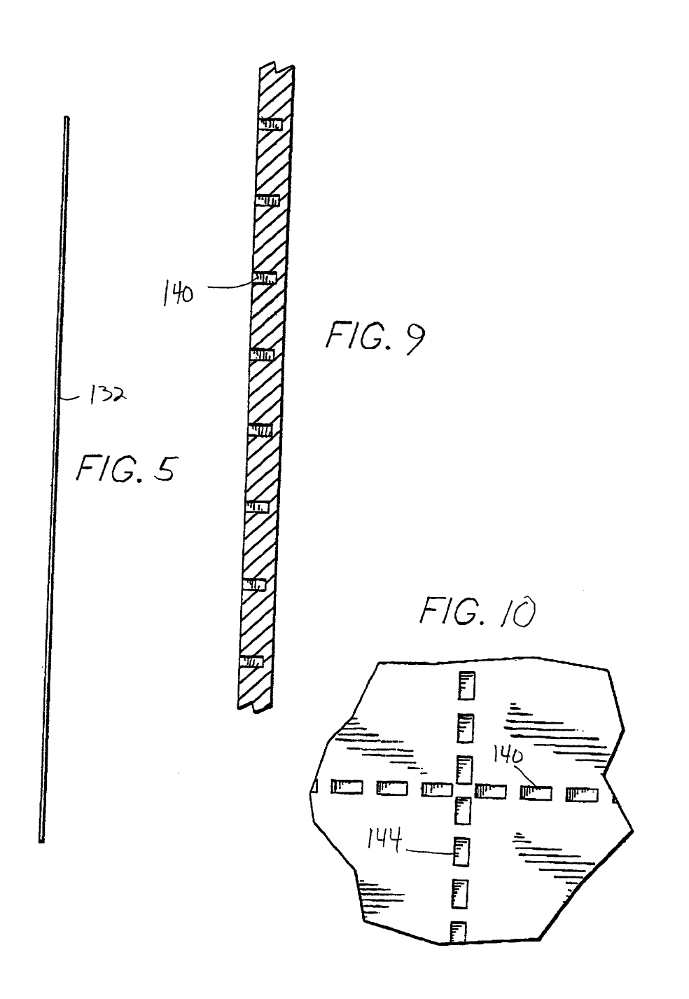

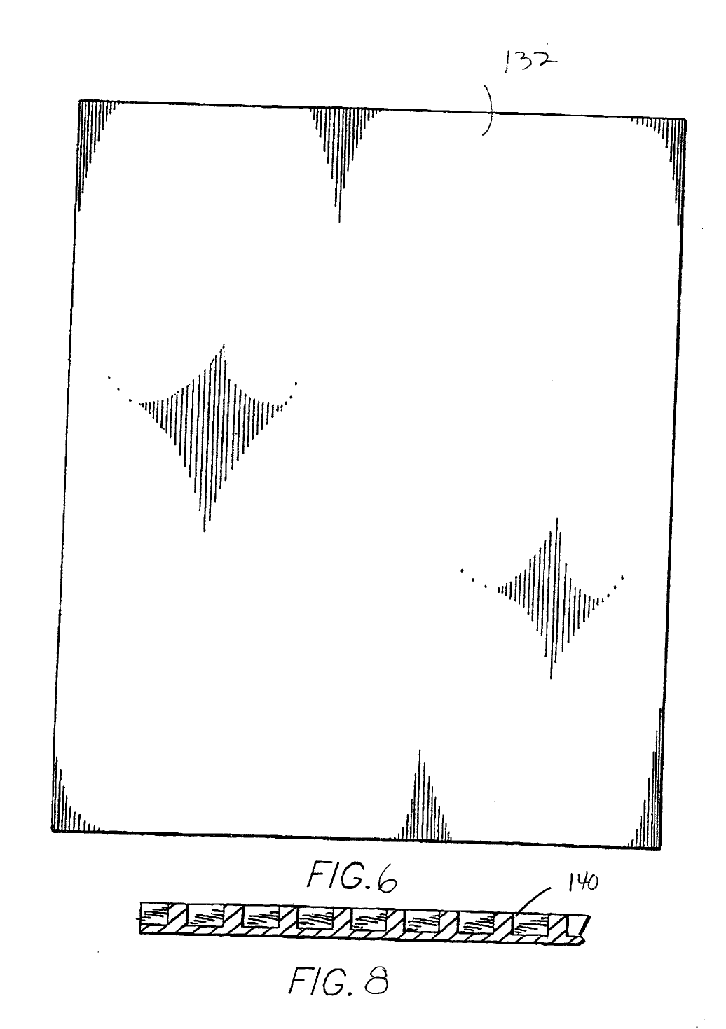

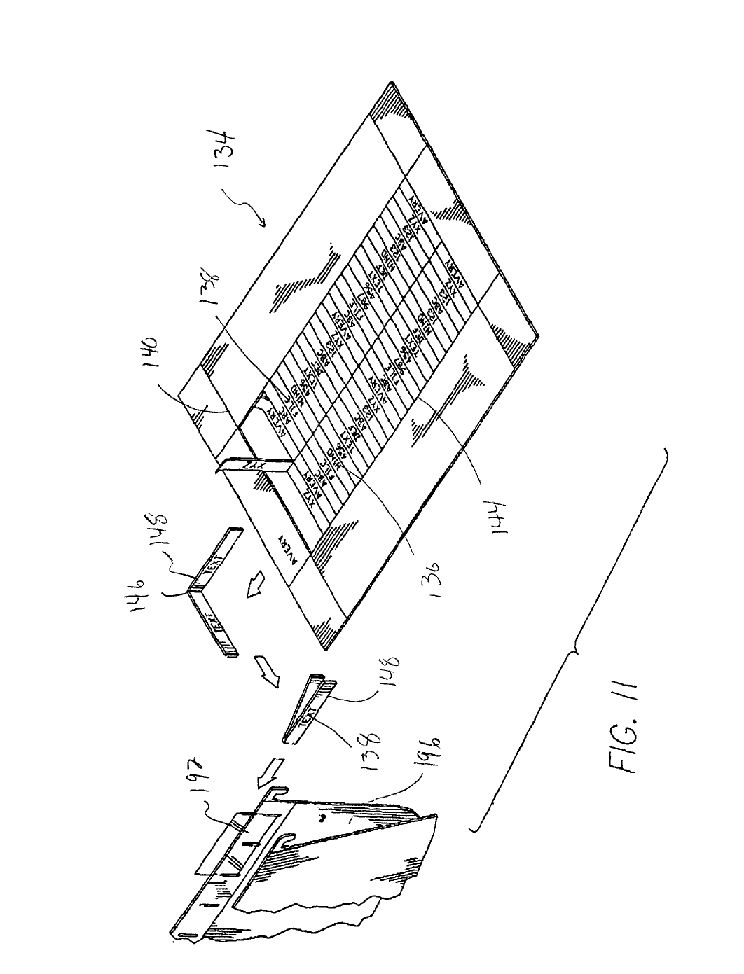

The perforated sheet 132 is shown in isolation and in enlarged detail in FIGS. 4-10, and preferred specifications for the sheet are now discussed. The sheet 132 is an 8½×eleven inch paper having a one hundred pound weight and a thickness of 7.0 to 7.3 mil, such as the one hundred pound tag white paper available from Crown Vintage. A pattern of horizontal and vertical microperforation lines 140, 144 and a central vertical perforation line 146 made with a microperf process define the twenty-six index tab inserts 148. The microperforations of the horizontal line 140 have dimensions of 0.0625 inch cut and 0.03125 inch tie and are formed with an eleven foot/inch pressure; and those of the vertical line 144 have dimensions of 0.02 inch cut and 0.007 inch tie and are formed with a thirty-seven foot/inch pressure. Likewise, the vertical perforation line 146 has dimensions of 0.025 inch cut, 0.007 inch tie, and thirty-one foot/inch pressure. The twenty-six tabs 148 are aligned in a single column 154 on the sheet. Referring to FIG. 4, they have the dimensions 158,162, 166, 170,174, 178, 182 and 186 of, respectively, 4.329, 1.171, 8.658, 0.333, 2.000, 2.000, 1.171 and 2.250 inches.

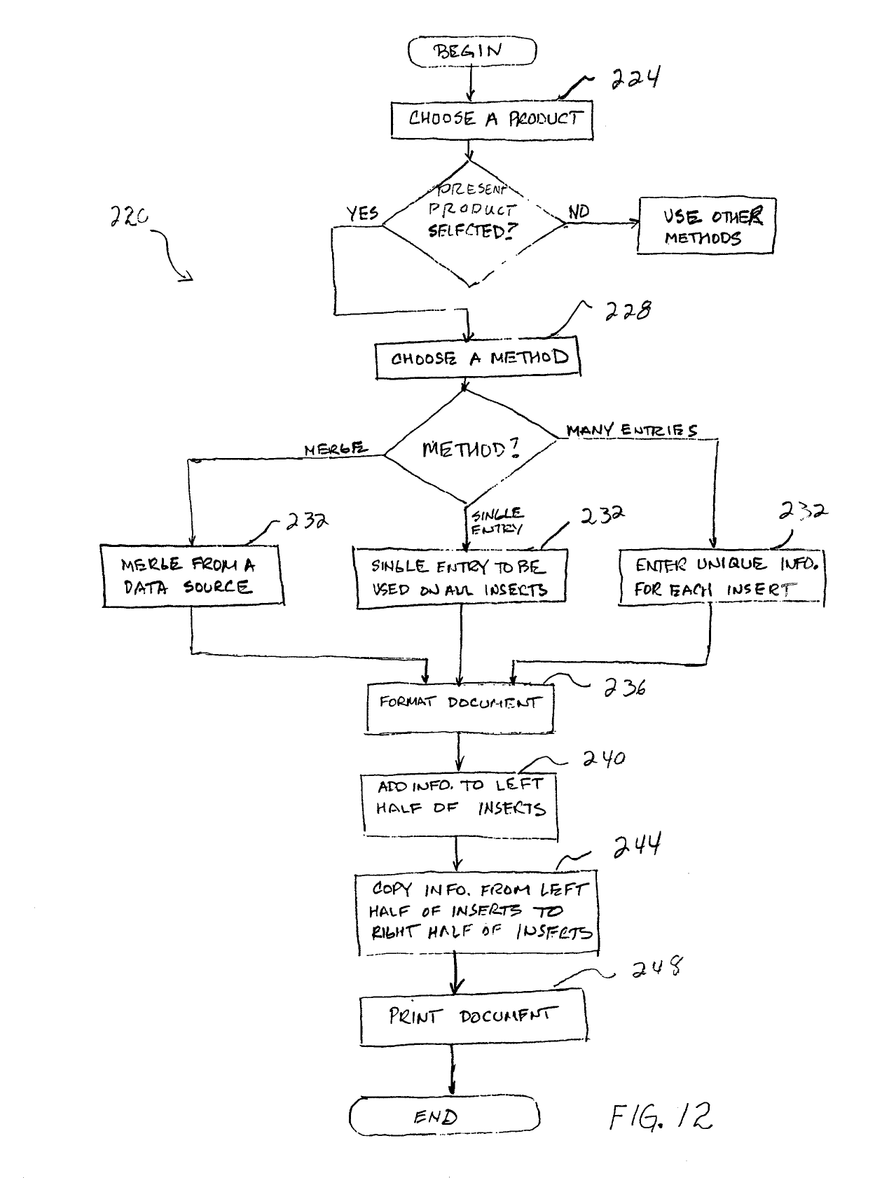

After the sheet 132 has been printed on by the printer 118 and been ejected as shown by sheet 134 in FIG. 3, it is removed by the user from the printer output tray as shown in FIG. 11. The inserts can then be separated from one another and the rest of the sheet by tearing along the vertical and horizontal microperforation lines 140, 144. After being separated, the inserts are folded in half on the central vertical perforation line 146. And the folded-over insert 148 with the printed titles or indicia 136, 138 facing outward are inserted into the transparent holders 192 extending out from the edge of the respective index tab divider or hanging file sheet 196.

The microperforated single column sheet 132 as described above, although having a lot of wasted paper, has a number of advantages over the prior art sheets. One of the prior art sheets has two columns of inserts with a gap or gutter in the middle. This gap causes problems with the (prior art) software, because software in general wants to see regular spacing from left to right. It wants each column to have the same width. Since the middle gutter column has a different width, the sheet cannot be formatted using the build-in label and insert formatting processes of many major word processing programs which are not designed for variation in the width of the columns.

Instead of the sheet 132 being formed of paper, it can be constructed of a film such as polyester film. Also, the vertical lines 144 instead of being microperforated can be formed as die cut lines, and paper strips adhered to the back side of the sheet against the die cut lines to hold them together. The die cut lines provide a cleaner edge than microperforations and thereby are preferred by many users. The strips are then peeled off after printing on the inserts.

Another alternative construction of the sheet 132 is to provide a continuous 8½×11 backing sheet and to attach the inserts to it using a “dry tack” (single use) adhesive. The inserts can be a sheet of a column of inserts separated from one another by microperforations. Alternatively and preferably, they can be individual and separate and positioned adjacent one another in a column arrangement.

The process of this invention pursuant to the computer program (on the disk 126, for example) is shown by the flow chart generally at 220 in FIG. 12. The operation is described in the TABLE below, and the numbers in the left column thereof correspond to the reference numerals in FIG. 12.

TABLE

| | | | |
|---|---|---|---|
| 224 | User | Choose the product | If the chosen product is the subject |
| | Action: | on which you want | product, then proceed with Step 228. |
| | | to print. | Otherwise, use other methods not |
| | | | covered here. |
| 228 | User | Choose a method of | There are several possible methods. All |
| | Action: | adding the informa- | the inserts on the sheet can be printed |
| | | tion that will print | with the same information. The |
| | | on each insert. | information for the inserts can be merged |
| | | | from a data file. The user can type |
| | | | unique information for each insert. |
| 232 | User | Add the information | Using one of the methods described |
| | Action: | that will print on | above. |
| | | each insert. | |
| 236 | Software | Format a document to | The document may be created in any of |
| | Action: | print correctly on | a number of different word processing |
| | | the inserts. | programs (such as Microsoft Word ®), or |
| | | | by a formatting module integral to the |
| | | | software being described. These |
| | | | documents will usually make use of the |
| | | | program’s ”table ” feature to create ”cells” |
| | | | that correctly position the information. |
| 240 | Software | Add the information | The information that is gathered in Step |
| | Action: | for each insert to the | 232 is added to the left half of each |
| | | left column of inserts. | insert. |
| 244 | Software | Copy the information | The information that is on the left half of |
| | Action: | from the left column | each insert is reproduced on the right |
| | | of inserts to the right | half of the same insert. |
| | | column of inserts. | |
| 248 | User | Print the document (on | The user starts the printing process. |
| | Action: | sheet 132 and with | |
| | | printer 118). | |

Referring to step 244 above, the copying of information from the left side of the inserts to the right side thereof can be performed at various times in the subject process. For example, the information can be copied as it is added and kept in the memory of the computer. Alternatively, the information can be copied just before the document is formatted so that it can be added to the document as it is being formatted. Another alternative of this invention includes the information being copied after the document has been formatted but before any information is placed on the document so that both columns are transferred to the document at the same time.

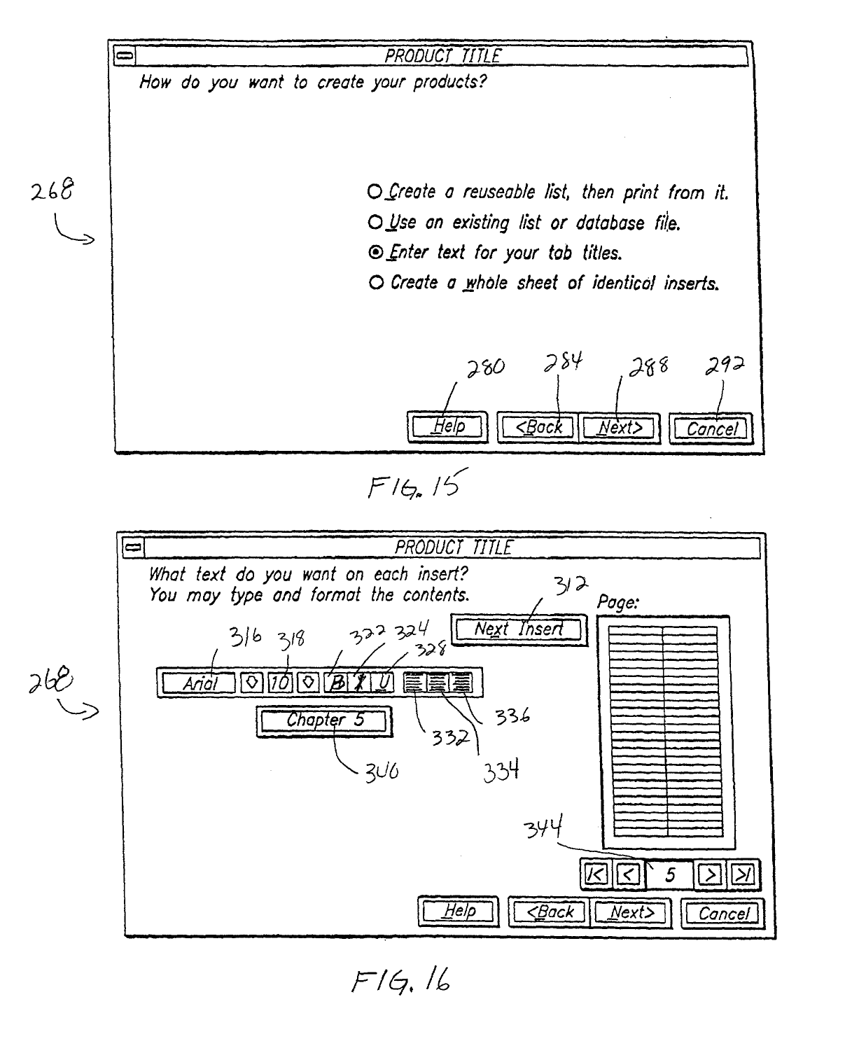

The computer software causes various information, instructions and user options to be displayed on the monitor 108. Various of these displays or screen shots are shown in FIGS. 13-17 at 260, 264, 268, 272 and 276, respectively. Each has Help 280, Back 284, Next 288 and Cancel 292 buttons which the user can click on so he can progress through the steps as desired.

Screen 260 is the opening screen of this program. The user selects the product to be printed by responding to the inquiries in screen 264 (see step 224 in FIG. 12). The various products are listed in the table 300. Identified therein are “Tab Inserts for Dividers—5 Tab” and “Tab Inserts for Dividers—8 Tab.” The columns of five-tab dividers are wider than for eight-tab dividers, because the tabs they are inserted into are longer. The small screen 304 at the right shows a drawing of the product highlighted in the table 300.

Referring to screen 268, the user selects the method to be used to print the dividers (see step 228 in FIG. 12). The “Enter text for your tab titled” method is designed for Tab Inserts for Dividers.

Screen 272 shows that the user can enter the information for each insert in the text edit area 340. Clicking on the “Next Insert” button 312 moves to the next insert. The number of the current insert 344 is shown, and the font 316 and type size 318 are displayed. In line therewith are the boldface 320, italics 324, underline 328, left align 332, center 334 and right align 336 buttons. Two adjacent cells (left and right) are selected at the same time.

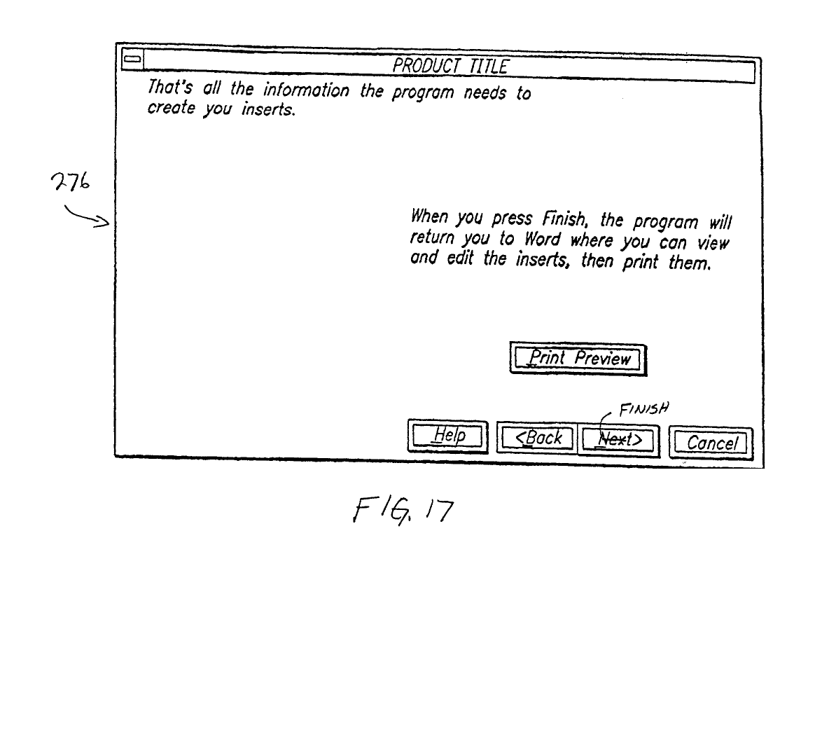

FIG. 17 shows the last screen 276 of the program. When the Finish (Next) button is pressed or clicked on, the table is constructed in Microsoft Word® and the information is copied to both columns of inserts.

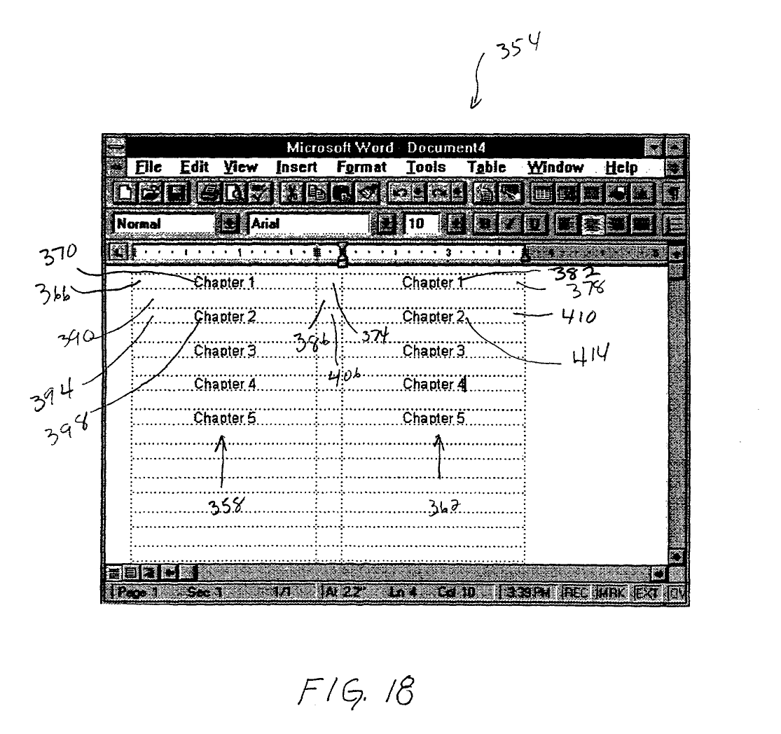

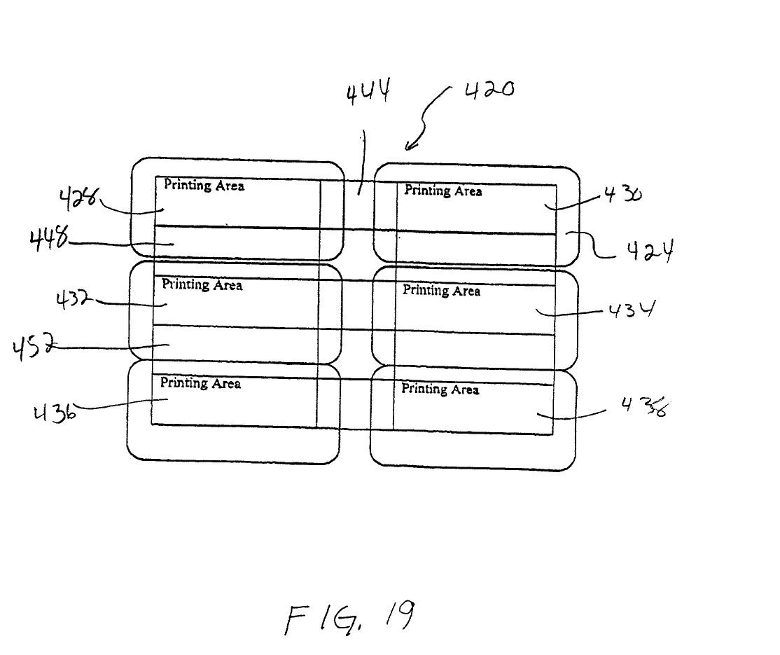

FIG. 18 shows the Word® screen at 350, where the construction of the table 354 and the two columns 358, 362 of information for the inserts are illustrated, and the user is ready to print the Tab Inserts for Dividers. In other words, the screen 354 does not show the microperforations (unlike FIG. 4 for example). Rather, it shows a document which was created in Word for Windows® and which is in the form of a table.

The “Copy info from left half of insert to right half of insert” step (step 244) on the flowchart of FIG. 12 is further defined below.

The product database (which is internal to the software) is checked to find the product type. The product database contains information about all of the products supported by the software. The information includes dimensions, margins, suggested font, suggested font style, suggested font size, product type and so on. If the product is the subject tab insert for divider product, continue with this process, otherwise use some other process. The user moves the insertion point to the first cell 366 of the table 354 in the formatted document. Text 370 for the first insert is placed into the cell 366 for the left side of the first insert. A copy is made (internal to the software) of the text (370) that is on the left side of the first insert. The user moves the insertion point to the right column 362 in the table, skipping cells 374 that are in spacing columns, to the cell 378 for the right side of the first insert. The copy of the text 382 for the right side of the first insert is placed into the cell 378 for the right side of the first insert. The user then moves the insertion point left in the table 354, skipping cells 386 that are in spacing columns, to the column 358 for the left side of the inserts, and down in the table, skipping cells 390 that are in spacing rows, to the cell 394 for the left side of the second insert. The text 398 for the second insert is placed into the cell 394 for the left side of the second insert. A copy is made (internal to the software) of the text that is on the left side of the second insert. The user moves the insertion point to the right in the table 354, skipping cells 406 that are in spacing columns, to the cell 410 for the right side of the second insert. The copy of the text 414 for the right side of the second insert is placed into the cell 410 for the right side of the second insert. And this process is continued for the remaining indicia or text.

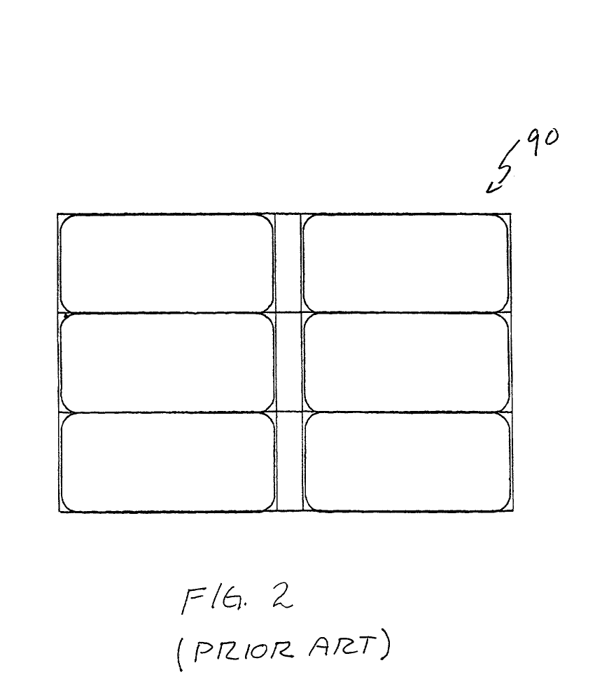

This table technology which includes the empty spacer rows and columns can be adapted and used for printing labels other than index divider tab inserts. An example is the adhesive labels as shown in FIG. 19. The table 420 is shown laid over the outline of the (six) labels 424. Similar to table 354, table 420 includes the printing cells 428, 430, 432, 434, 436, 438, the empty spacer column 444 and the empty spacer rows 448, 452. This is to be contrasted with the prior art table 90 in FIG. 2 which does not have empty spacer columns or rows.

This prior art problem of the printing running off the edge of the labels is due to label manufacturing variation, printer manufacturing variation and/or printer feed variation. Because label manufacturing is a high-speed process, there is a certain amount of variation in the position of the labels on the carrier sheet from sheet to sheet and from lot to lot. Because of manufacturing variations in printers, they do not all place the image at the same position on the page. Because desktop laser printers use unsophisticated paper feeding and paper positioning mechanisms, there is a variation in the image position on the page from sheet to sheet with the same printer. Thus, if one attempts to print too close to the edge of the label, the printing may run off the side of labels on some sheets due to different label positioning, printer variations and/or paper positioning and feed variations.

In other words, the subject computer program builds complex tables in Microsoft Word® that include extra rows and columns between the cells that contain information that prints. These extra rows and columns provide for space between labels where those products are laid out on the sheet with gutters between them, as has been done by others in the past. However, they also uniquely provide for margins around the edges of the individual labels themselves. These margins help the user create aesthetically-pleasing designs by providing appropriate margins on the label. They also help insure that the printing on the individual labels never runs off the edge of the labels, which was a problem in the prior art.

Many products can take advantage of this technology of forced margins provided by gutter columns and rows. Examples of such products are labels (addressing and shipping labels, identification labels, name badge labels, file folder labels, diskette labels, audio tape labels, video tape labels, and index tab labels), cards (business cards, index cards, postcards, rotary index cards, tent cards, note cards, greeting cards and identification cards), inserts (tab inserts for hanging file folders, tab inserts for dividers, tab inserts for self-adhesive tabs and binder spine inserts), tags (name badge tags, shipping tags, inventory tags, and identification tags) and table of contents sheets. In other words, this technology can be adapted for generally any product that has multiple discrete printing areas on a sheet.

Compared with the prior art label printing software, the present system is very user friendly. Common English words are used in the instructions, as can be understood from the screen shots of FIGS. 13-18. Each computer screen has a well defined small task for the user to complete, and the following screen is easily accessed by clicking on the “Next” button 288. It is a very orderly process, and thus a significant improvement over the prior art.

A further alternative of the present invention is instead of installing the program via a computer disk (126), the program or software can be down loaded by the user directly from the Internet. The program can be an applett which runs on top of the computer's operating system and does not attach to the hard drive. Alternatively, it can be an activex program. A step-by-step description of how an applett or activex program is used to distribute the subject software follows.

1. User connects to the Internet or network.

2. User contacts the host computer via the Internet or network.

3. User requests the host computer to transfer the program to the user's computer.

4. Host computer sends the program over the Internet or network to the remote user.

5. User's computer receives the program from the host computer via the Internet.

6. User executes the applett program using any operating system.

6.5 User executes the activex program using Windows operating system.

7. (Program works the same as previously described.)

Appletts are written with the Java language. One distinguishing characteristic of appletts is that they can be included in an HTML page, just like an image is included. When the HotJava browser is used to view a page that contains an applett, the applett's code is transferred to the user's system and is executed by the browser.

Most often, appletts are small applications that are given a piece of rectangular real estate inside a Web document to interact with the user. However, an applett can also create top-level windows. Simply, applett is just a piece of code, and all that implies.

Today's applications are mostly machine and platform specific. That is, the application binary files must be compiled separately for each platform, whether it is Microsoft Windows, OS/2, the Solaris™ operating environment, or NetWare. For developers, delivering applications for multiple platforms means re-writing and re-compiling lots of code. The Java Platform enables delivery of highly interactive, dynamic, and secure appletts and applications on networked computer systems. What sets the Java Platform apart is that it sits on top of current software platforms, and compiles to byte codes, which are not specific to any physical machine, but are machine instructions for a virtual machine. A program written in the Java Language compiles to a byte code file that can run wherever the Java Platform is present, on any underlying operating system. In other words, the same exact file can run on any operating system that supports the Java Platform. This portability is possible because at the core of the Java Platform is the Java Virtual Machine. While each underlying platform has its own implementation of the Java Virtual Machine, there is only one virtual machine specification. Because of this, the Java Platform can provide a standard, uniform programming interface to appletts and applications on any hardware. The Java Platform is therefore ideal for the Internet, where one program must be capable of running on any computer in the world. The Java Platform is designed to provide this Write Once, Run Anywhere™ capability.

Developers use the Java Language to write source code for Java-powered applications. They compile once to the Java Platform, rather than to the underlying system. Java Language source code compiles to an intermediate, portable form of byte codes that will run anywhere the Java Platform is present.

Developers can write object-oriented, multi-threaded, dynamically-linked applications using the Java Language. The platform has built-in security, exception handing, and automatic garbage collection. Just-in-time compilers are available to speed up execution by converting Java byte codes into machine language. From within Java Language, developers can also write and call native methods in C, C++ or another language, compiled to a specific underlying operating system for speed or special functionality. JavaOS is designed for Network Devices.

The Java Platform enables development of simple, intelligent and dynamic network devices. A simple network device, by definition, has limited hardware and resources which make it easy to install, administer and use. Installation is as simple as plugging the device into a network and a power supply and turning it on. An intelligent network device is capable of executing programs locally, even though it is inherently network-oriented. A dynamic network device is not limited to a static set of programs contained in local storage; instead, it can automatically load and run new programs over the network. Developed by JavaSoft®, the JavaOSTM operating environment is a small and efficient operating environment designed specifically to support these types of Java devices and the Java Platform. The JavaOS executes Java applications directly on hardware platforms, while eliminating much of the overhead typically required by a host operating system. Thus, these network devices require less local memory and disk space, making them more cost-effective to purchase and easier to maintain. JavaOS makes it possible to develop secure, high performance, and highly robust intelligent and dynamic network devices built on multiple hardware platforms in heterogeneous, distributed networks. For more detailed information about the features and architecture of the Java Platform and JavaOS, refer to the Developer's Corner at the JavaSoft Web site, http://java.sun.com, which is hereby incorporated by reference.

ActiveX® is a technology and set of programming tools from Microsoft for building interactivity with users into Web pages and application programs. ActiveX includes what Microsoft used to call Object Link Embedding (OLE) and adds more. There are ActiveX controls and ActiveX documents. Controls are objects that can be imbedded into Web pages (for example, small messages that pop up unexpectedly or images that become active when selected with a mouse) or into application programs off the Web. Controls are roughly similar to Java appletts. Documents are objects that are viewable and navigable with a viewer.

ActiveX is a technology developed by Microsoft for sharing information among different applications. ActiveX is an outgrowth of two other Microsoft technologies called OLE (Object Linking and Embedding) and COM (Component Object Model). ActiveX supports new features that enable it to take advantage of the Internet. For example, an ActiveX control can be automatically downloaded and executed by a Web browser. ActiveX is not a programming language, but rather a set of rules for how applications should share information. Programmers can develop ActiveX controls in a variety of languages, including C, C++, Visual Basic, and Java. An ActiveX control is similar to a Java applett. Unlike Java appletts, however, ActiveX controls have full access to the Windows operating system. This gives them much more power than Java appletts, but with this power comes a certain risk that the applett may damage software on the user's machine. To control the risk, Microsoft developed a registration system so that browsers can identify and authenticate an ActiveX control before downloading it. Another difference between Java appletts and ActiveX controls is that Java appletts run on all platforms, whereas ActiveX controls are currently limited to Windows environment.

Related to ActiveX is a scripting language called VBScript that enables Web authors to embed interactive elements in HTML documents. Just as JavaScript is similar to Java, so VBScript is similar to Visual Basic. Currently, Microsoft's Web browser, Internet Explorer, supports Java, JavaScript, and ActiveX, whereas Netscape's navigator browsers support only Java and JavaScript.

From the foregoing detailed description, it will be evident that there are a number of changes, adaptations and modifications of the present invention which come within the province of those skilled in the art. However, it is intended that all such variations not departing from the spirit of the invention be considered as within the scope thereof as limited solely by the claims appended hereto.

What is claimed is:

1. A method of printing indicia on discrete printing areas of a sheet, said method comprising the steps of:
(a) executing program code to format a document comprising a table having first and second columns and a spacer column therebetween, and first and second rows and a spacer row therebetween, wherein the area defined by the intersection of the first column and the first row defines a first cell, the area defined by the intersection of the second column and the first row defines a second cell, the area defined by the intersection of the first column and the second row defines a third cell, and the area defined by the intersection of the second column and the second row defines a fourth cell; wherein indicia in the first cell represents the indicia to be printed on a first printing area of a sheet having first, second, third and fourth discrete printing areas as the sheet is passed through a printer, and indicia in the second, third, and fourth cells represent the indicia to be printed on the second, third and fourth printing areas, respectively;
(b) adding first indicia in the first cell;
(c) adding second indicia in the second cell;
(d) adding third indicia in the third cell; and
(e) adding fourth indicia in the fourth cell.

2. The method of claim 1 wherein the spacer rows and columns maintain printing margins of the indicia when printed on the printing areas of the sheet.

3. The method of claim 1 wherein the printing areas define portions of a body of the sheet and separable generally from one another after the indicia have been printed thereon.

4. The method of claim 1 wherein the first and second printing areas define a single, continuous index divider label.

5. The method of claim 4 wherein the index divider label comprises a foldable index divider label insert.

6. The method of claim 1 wherein the indicia comprise index divider titles.

7. The method of claim 1 wherein the sheet includes a backing sheet and the printing areas define labels releasably adhered to the backing sheet.

8. The method of claim 1 wherein the first and second printing areas are row-adjacent to one another on the sheet, the third and fourth printing areas are row-adjacent to one another, the first and third printing areas are column-adjacent to one another and the second and fourth printing areas are column-adjacent.

9. The method of claim 1 further comprising: (f) automatically making internal to computer software a copy of the first indicia, wherein the copied first indicia comprises the second indicia.

10. The method of claim 9 wherein step (f) includes storing the copied first indicia in computer memory before step (c).

11. The method of claim 10 further comprising: (g) automatically making internal to the computer software a copy of the third indicia, wherein the copied third indicia comprises the fourth indicia.

12. The method of claim 11 wherein step (g) includes storing the copied third indicia in the computer memory before step (e).

13. The method of claim 9 wherein the first and third indicia are the same.

14. The method of claim 9 wherein step (a) is before steps (b), (c), (d) and (e), and steps (b), (c), (d) and (e) are at the same time.

15. The method of claim 9 wherein step (f) is before step (a).

16. The method of claim 15 wherein step (c) is during step (a).

17. The method of claim 1 wherein the first and third indicia are merged from an existing data source.

18. The method of claim 1 wherein the first and third indicia are individually input by a computer user.

19. The method of claim 1 wherein the printing areas are separable labels.

20. The method of claim 1 wherein the printing areas are separable cards.

21. The method of claim 1 wherein the printing areas are separable inserts.

22. The method of claim 1 wherein the printing areas are separable tags.

23. The method of claim 1 wherein the sheet is a table of contents sheet.

24. The method of claim 1 wherein said executing is on a “thin client” computer.

25. The method of claim 1 wherein said executing is on Web television.

26. The method of claim 1 wherein said executing is on a computer accessing the Internet.

27. The method of claim 1 wherein said executing is on a personal desktop computer.

28. The method of claim 1 wherein said executing uses an applett program.

29. The method of claim 1 wherein said executing uses an ActiveX program.

30. A computer-readable memory containing program instructions for:
formatting an index divider label document;
adding indicia to one portion of the document;
automatically copying the indicia; and
adding the copied indicia to another portion of the document.

31. The computer-readable memory containing program instructions of claim 30 wherein the index divider label comprises an index divider strip having a first half comprising the one portion and a second half comprising the another portion, the first and second halves being foldable on one another.

32. The computer-readable memory containing program instructions of claim 30 further comprising before said adding, inquiring from a user as to the indicia to be added.

33. The computer-readable memory containing program instructions of claim 32 wherein said inquiring includes the user choosing from one of a plurality of alternative inputting methods.

34. The computer-readable memory containing program instructions of claim 33 wherein the methods include merging information from an existing data source, and inputting new information.

35. The computer-readable memory containing program instructions of claim 30 wherein said copying includes copying the indicia as the indicia is added to the one portion and storing it in computer memory.

36. The computer-readable memory containing program instructions of claim 35 wherein said adding the copied indicia includes obtaining the copied indicia from the computer memory.

37. The computer-readable memory containing program instructions of claim 30 further comprising instructing, pursuant to a user prompt, a printer to print the indicia on right and left halves of an index tab insert on a sheet of index tab inserts.

38. The computer-readable memory containing program instructions of claim 30 wherein the inputting new information method is selected from the group of methods of using the same indicia on all inserts on a sheet and of using individual indicia on each of the inserts on a sheet, one of which is to be chosen by the user during said choosing step.

39. The computer-readable memory containing program instructions of claim 30 wherein said copying is after the document has been formatted.

40. The computer-readable memory containing program instructions of claim 39 wherein the indicia and the copied indicia are added at the same time to the respective portions of the formatted document.

41. The computer-readable memory containing program instructions of claim 30 wherein said copying includes copying the indicia before the document is formatted.

42. The computer-readable memory containing program instructions of claim 41 wherein said adding the copied indicia includes adding it as the document is being formatted.

43. The computer-readable memory containing program instructions of claim 30 of claim wherein said formatting includes using a table having columns and rows defining a matrix of cells for positioning the indicia and copied indicia.

44. The computer-readable memory containing program instructions of claim 43 wherein the cells are only on alternating rows in the table.

45. The computer-readable memory containing program instructions of claim 43 wherein the cells are only on alternating columns in the table.

46. The computer-readable memory containing program instructions of claim 43 wherein the cells are only in the areas defined by alternating ones of the columns and the rows.

47. A system for printing the same indicia on both portions of a tab insert, comprising:
a data processor;
a printer operatively connected to said data processor;
a user input operatively connected to said data processor;
a sheet having defined thereon at least one column of tab inserts separable therefrom after having passed through said printer and a printing operation having been conducted thereon; and
instruction means operatively in said data processor and containing program instructions for causing indicia, as instructed by a user through said user input, for printing on one portion of one of said tab inserts, to be automatically copied and the indicia and the copied indicia to subsequently be printed by said printer on the one portion and another portion, respectively, of one of said tab inserts.

48. The system of claim 47 wherein said instruction means is insertable into said data processor in a computer disk.

49. The system of claim 47 wherein said printer comprises a laser printer.

50. The system of claim 47 wherein said sheet includes a single column of said tab inserts centered on said sheet with wide waste sheet margins on both sides on the top and bottom of said sheet, said tab dividers being separated from one another by microperforations lines.

51. The system of claim 50 wherein said sheet includes at least one microperforation line extending from an edge of said sheet to said column for tear accessing said column and thereby said tab dividers for separation.

52. The system of claim 50 wherein the microperforation lines defining the two sides of said column both extend to the top and bottom edges of said sheet and the microperforation lines defining the two ends of the column extend to the two sides of said sheet.

53. The system of claim 47 wherein said user input comprises a keyboard or mouse.

54. The system of claim 47 wherein said tab inserts comprise tab inserts for hanging file folders.

55. The system of claim 47 wherein said tab inserts comprise tab inserts for dividers.

56. The system of claim 47 wherein said data processor includes a personal desktop computer.

57. The system of claim 47 wherein said data processor includes a network computer.

58. The system of claim 47 wherein said data processor includes a thin client computer.

59. The system of claim 47 wherein said data processor includes a Web television.

60. The system of claim 47 wherein said instruction means includes an ActiveX program.

61. The system of claim 47 wherein said instruction means includes an applett program.

62. The system of claim 47 wherein said instruction means is accessed through the Internet.

63. The system of claim 47 wherein said sheet is a sheet of paper.

64. The system of claim 47 wherein said sheet is a polyester film.

65. The system of claim 47 wherein said column has at least a portion of a perimeter thereof defined by an elongate cut line through said sheet.

66. The system of claim 65 further comprising a backing strip releasably adhered at said cut line on a back side of said sheet.

67. A data processing method of automatically printing the same titles on both halves of tab inserts, comprising the steps of:
(a) formatting a tab insert document;
(b) adding a title to one portion of the document representing one half of a tab insert;
(c) automatically copying internal to software the title; and
(d) adding the copied title to another portion of the document representing another half of the tab insert.

68. The method of claim 67 wherein step(a) is conducted in a computer.

69. The method of claim 68 wherein step (c) includes storing the copied title in computer memory before step (d).

70. The method of claim 68 wherein step (a) is before steps (b), (c) and (d), and steps (b) and (d) are at the same time.

71. The method of claim 68 wherein step (c) is before step (b).

72. The method of claim 68 wherein step (d) is during step (a).

73. The method of claim 68 wherein the tab inserts comprise tab inserts for hanging file folders.

74. The method of claim 68 wherein the tab inserts comprise tab inserts for dividers.
